(19) United States
(12) Patent Application Publication
(10) Pub. No.: US 2026/0155609 A1
(43) Pub. Date: Jun. 4, 2026

(54) ELECTRICAL CONNECTOR

(71) Applicant: LOTES CO., LTD., Keelung (TW)

(72) Inventors: Wen-Chang Chang, Keelung (TW); Zhuang-Fei Fu, Guangzhou (CN); Xiao-Ping Yi, Guangzhou (CN); Biao Zhang, Guangzhou (CN); Lang Li, Guangzhou (CN); Qing-Cheng Zeng, Guangzhou (CN); Ting Qin, Guangzhou (CN)

(21) Appl. No.: 19/284,796

(22) Filed: Jul. 30, 2025

(30) Foreign Application Priority Data
Dec. 4, 2024 (CN) 202411779765.X
Jan. 8, 2025 (CN) 202510032228.7

(51) Int. Cl. H01R 13/6585; H01R 12/70; H01R 12/73; H01R 13/6594

(52) U.S. Cl. CPC H01R 13/6585; H01R 12/707; H01R 12/737; H01R 13/6594

(57) ABSTRACT

An electrical connector includes an insertion slot, two terminal rows, a lossy member and at least one metal sheet. The two terminal rows are located at two sides of the insertion slot along the front-rear direction. Each terminal row includes a plurality of signal terminals and a plurality of ground terminals arranged side-by-side along a left-right direction. The metal sheet is provided between the lossy member and a corresponding terminal row. The lossy member runs through the metal sheet to be electrically coupled to the ground terminals. Along the front-rear direction, the metal sheet shields the signal terminals, such that the lossy member does not absorb (or reducing the portion of) the signal transmitted by each signal terminal toward a receiving end (such as a system), thereby optimizing the insertion loss of the electrical connector, and enhancing the SI of the electrical connector.

### CROSS-REFERENCE TO RELATED PATENT APPLICATION

This non-provisional application claims priority to and the benefit of, pursuant to 35 U.S.C. § 119 (a), patent application Serial No. CN202411779765.X, filed in China on Dec. 4, 2024, and patent application Serial No. CN202510032228.7, filed in China on Jan. 8, 2025. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electrical connector, and particularly to an electrical connector improving high frequency characteristics.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An existing electrical connector includes an insulating body, a lossy member, ground terminals and signal terminals. The lossy member functions as a shielding structure to be electrically coupled to the ground terminals, which may absorb the noise between the signal terminals and reduce the crosstalk, thus having good shielding effect, and enhancing the high frequency characteristics of the electrical connector.

However, the lossy member, due to its material characteristics, while absorbing the noise between the signal terminals, may also absorb the signal transmitted by each signal terminal toward the receiving end (such as a system). Thus, the insertion loss of the electrical connector may increase, such that the signal integrity (hereinafter referred to as SI) of the electrical connector is deteriorated, and the high frequency characteristics of the electrical connector is to be further improved.

Therefore, a heretofore unaddressed need to design an electrical connector exists in the art to address the aforementioned deficiencies and inadequacies.

### SUMMARY

The present invention is directed to an electrical connector, in which a metal sheet is utilized to isolate the signal terminals and the lossy member, thereby improving high frequency characteristics.

To achieve the foregoing objective, the present invention adopts the following technical solution:

An electrical connector includes: a shell, comprising an insertion slot to be inserted by a mating component; two terminal rows accommodated in the shell, wherein the two terminal rows are respectively provided at two sides of the insertion slot along a front-rear direction, each of the terminal rows comprises a plurality of signal terminals and a plurality of ground terminals arranged in a left-right direction, each of the signal terminals comprises a signal contact portion inserted into the insertion slot and a signal elastic portion extending downward from the signal contact portion; a lossy member, provided between the two terminal rows, wherein the lossy member comprises a main body and at least one protruding portion protruding toward a corresponding one of the ground terminals from the main body; an insulating plug member, provided between the two terminal rows, wherein the insulating plug member comprises a body portion and a plurality of protruding strips formed by extending upward from the body portion; and at least one metal sheet, provided between the main body and a corresponding one of the terminal rows, wherein the metal sheet comprises a plurality of opening slots and a plurality of isolating portions, the protruding portion passes through a corresponding one of the opening slots to be electrically coupled to the corresponding one of the ground terminals, and the isolating portions are located between the signal terminals and the insulating plug member.

To achieve the foregoing objective, the present invention further adopts the following different technical solution:

An electrical connector includes: a shell, comprising an insertion slot to be inserted by a mating component; two terminal rows accommodated in the shell, wherein the two terminal rows are respectively provided at two sides of the insertion slot along a front-rear direction, each of the terminal rows comprises a plurality of signal terminals and a plurality of ground terminals arranged in a left-right direction, each of the signal terminals comprises a signal contact portion inserted into the insertion slot and a signal elastic portion extending downward from the signal contact portion; a lossy member, provided between the two terminal rows, wherein the lossy member comprises a main body and at least one protruding portion protruding toward a corresponding one of the ground terminals from the main body, and a lowest location of the lossy member is lower than a bottom surface of the insertion slot; and at least one metal sheet, provided between the main body and a corresponding one of the terminal rows, wherein the metal sheet comprises a plurality of opening slots and a plurality of isolating portions, the protruding portion passes through a corresponding one of the opening slots to be electrically coupled to a corresponding one of the ground terminals, and the isolating portions shield the signal terminals along the front-rear direction.

Compared to the related art, the present invention has the following beneficial effects:

The lossy member runs through the opening slots of the metal sheet to be electrically coupled to the ground terminals of the electrical connector, thus forming a grounding circuit between the lossy member and the ground terminals, thereby optimizing the shielding effect. The lossy member is provided between the two terminal rows, thus reducing the crosstalk between the two terminal rows. The metal sheet is added between the signal terminals and the lossy member, and the metal sheet shields the lossy member and the signal terminals, such that the lossy member does not absorb (or reducing the portion of) the signal transmitted by each signal terminal toward a receiving end (such as a system), thereby optimizing the insertion loss of the electrical connector, and enhancing the SI of the electrical connector.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective view of an electrical connector being mounted to a circuit board and mated with a mating component according to a first embodiment of the present invention.

FIG. 2 is a perspective exploded view of the electrical connector, the mating component and the circuit board in FIG. 1.

FIG. 3 is a perspective exploded view of certain components of the electrical connector in FIG. 1.

FIG. 4 is a plain view of certain components of the electrical connector and the circuit board in FIG. 1.

FIG. 5 is a sectional view of the electrical connector and the circuit board in FIG. 1 along a plane on which the Z-axis and the Y-axis are located.

FIG. 6 is a side view of certain components of the electrical connector in FIG. 1.

FIG. 7 is a top view of certain components of the electrical connector in FIG. 1.

FIG. 8 is a perspective view of certain components of the electrical connector and the circuit board in FIG. 1.

FIG. 9 is a plain view of certain terminal groups of the electrical connector in

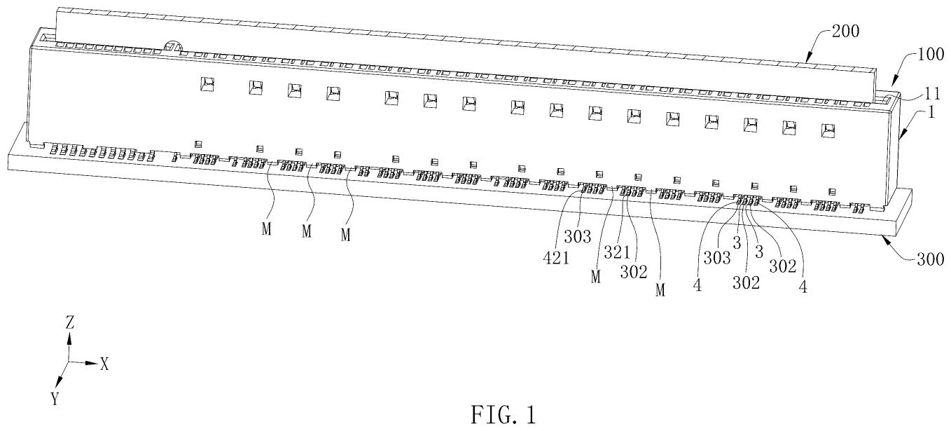

FIG. 1.

FIG. 10 is a perspective view of an electrical connector according to a second embodiment of the present invention.

FIG. 11 is a perspective exploded view of the electrical connector in FIG. 10.

FIG. 12 is a plain view of certain components of the electrical connector and the cable in FIG. 10.

FIG. 13 is a side view of certain components of the electrical connector in FIG. 10.

FIG. 14 is a perspective sectional view of certain components of the electrical connector and the mating component in FIG. 10 along one of the planes on which the Z-axis and the Y-axis are located.

FIG. 15 is a perspective sectional view of certain components of the electrical connector and the mating component in FIG. 10 along another one of the planes on which the Z-axis and the Y-axis are located.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated. As used herein, the terms “comprising”, “including”, “carrying”, “having”, “containing”, “involving”, and the like are to be understood to be open-ended, i.e., to mean including but not limited to.

The description will be made as to the embodiments of the present invention in conjunction with the accompanying drawings in FIGS. 1-15. In accordance with the purposes of this invention, as embodied and broadly described herein, this invention, in one aspect, relates to an electrical connector.

For better understanding, in the present invention, an extending direction of the X-axis is defined as a left-right direction, in which the positive direction of the X-axis is rightward. An extending direction of the Y-axis is defined as a front-rear direction, in which the positive direction of the Y-axis is forward. An extending direction of the Z-axis is defined as a vertical direction, in which the positive direction of the Z-axis is upward. An interval is defined as a length between centers of two components, and a distance is defined as a length between edges of two components.

FIG. 1 to FIG. 9 show an electrical connector according to a first embodiment of the present invention. The electrical connector 100 is used to mate with a mating component 200 in the vertical direction. The electrical connector 100 includes a shell 1, two plastic blocks 2, a plurality of signal terminals 3, a plurality of ground terminals 4, a lossy member 5, an insulating plug member 6 and two metal sheets 7.

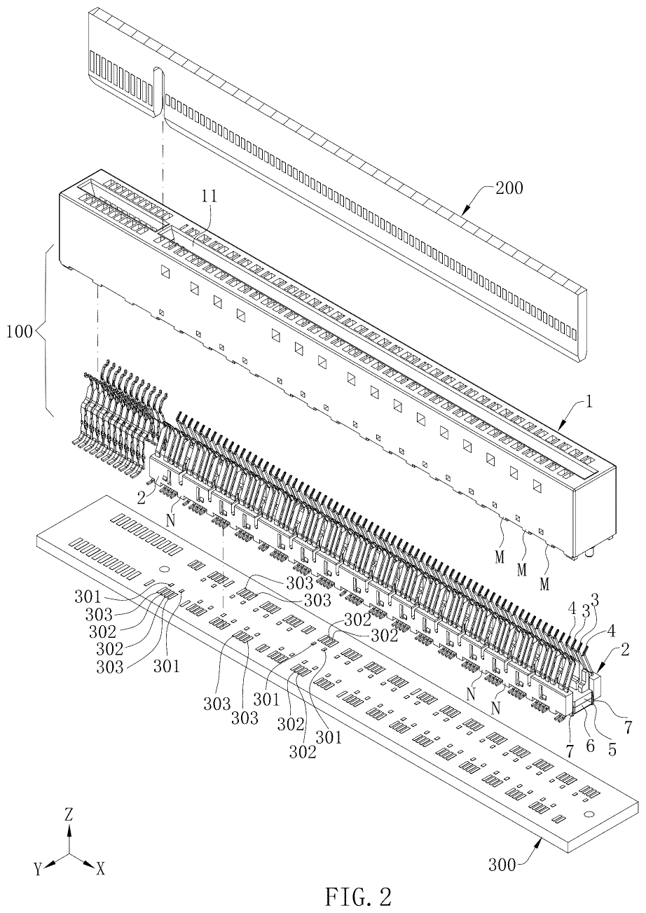

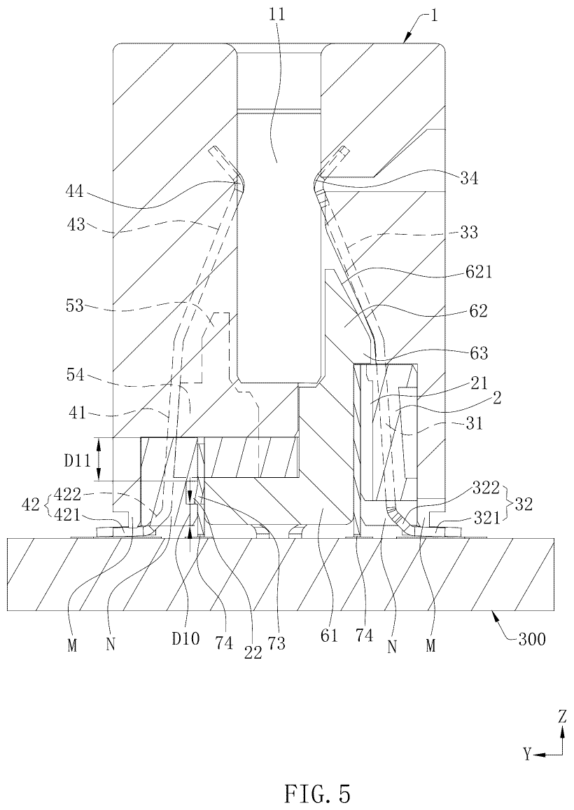

Referring to FIG. 1, FIG. 2 and FIG. 5, the shell 1 is provided with an insertion slot 11 to be inserted by the mating component 200, and a plurality of separation blocks M are formed by extending downward from a lower surface of the shell 1.

Referring to FIG. 2 and FIG. 5, the two plastic blocks 2 are accommodated in the shell 1, and the two plastic blocks 2 are provided at two sides of the insertion slot 11 along the front-rear direction. A side of each plastic block 2 facing toward the insertion slot 11 is provided with a plurality of guiding slots 21 formed by extending upward from a lower surface thereof, and the guiding slots 21 do not run through an upper surface of each plastic block 2. The side of each plastic block 2 facing toward the insertion slot 11 is further provided with a plurality of fixing slots 22 formed by recessing along the front-rear direction. A plurality of spacer blocks N are formed by extending downward from the lower surface of each plastic block 2, and the spacer blocks N and the separation blocks M one-to-one correspond to each other and are aligned in the front-rear direction.

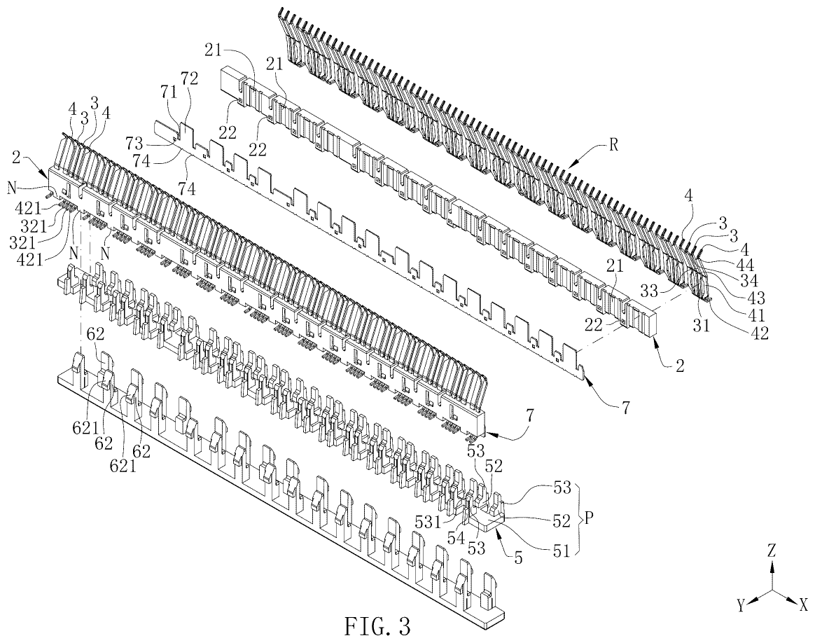

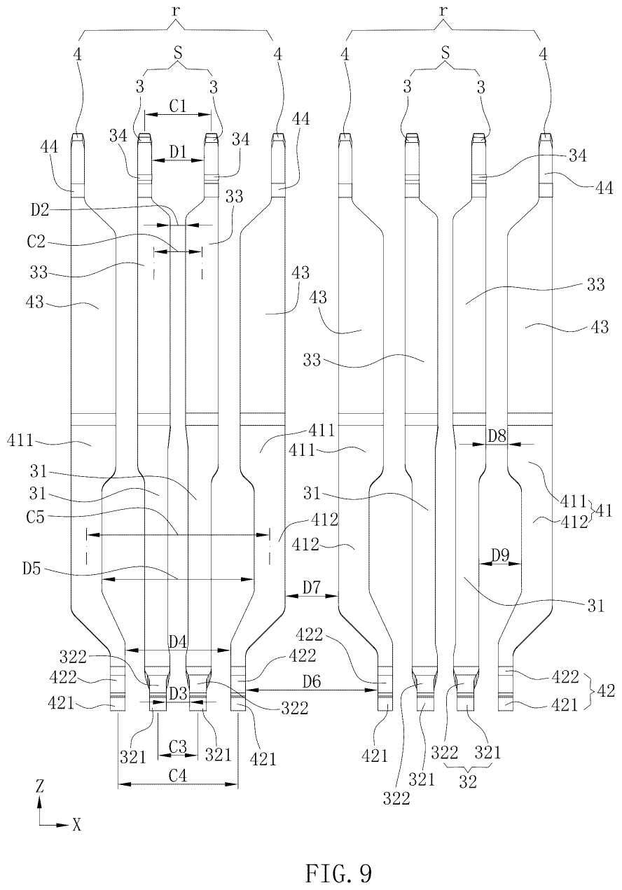

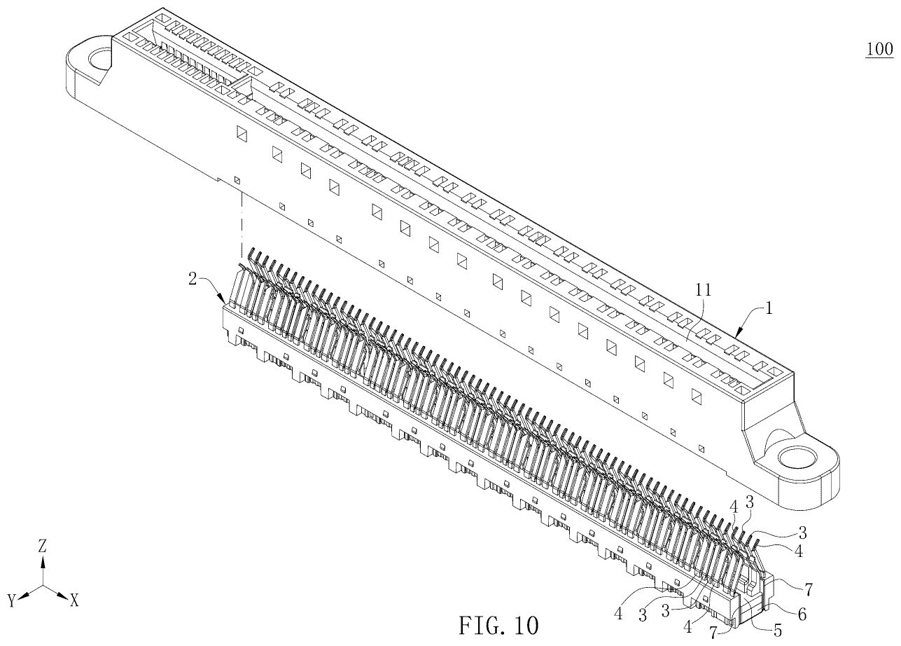

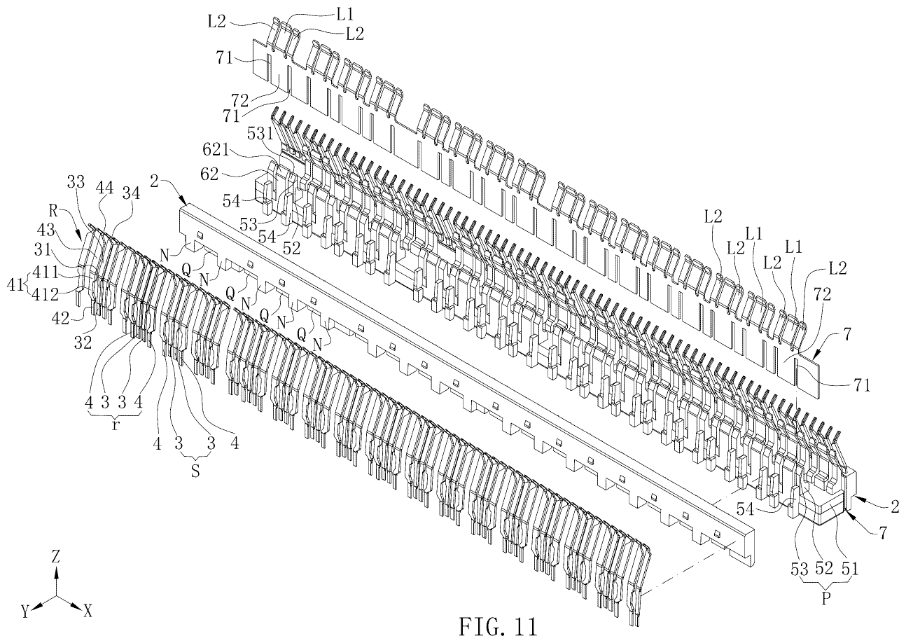

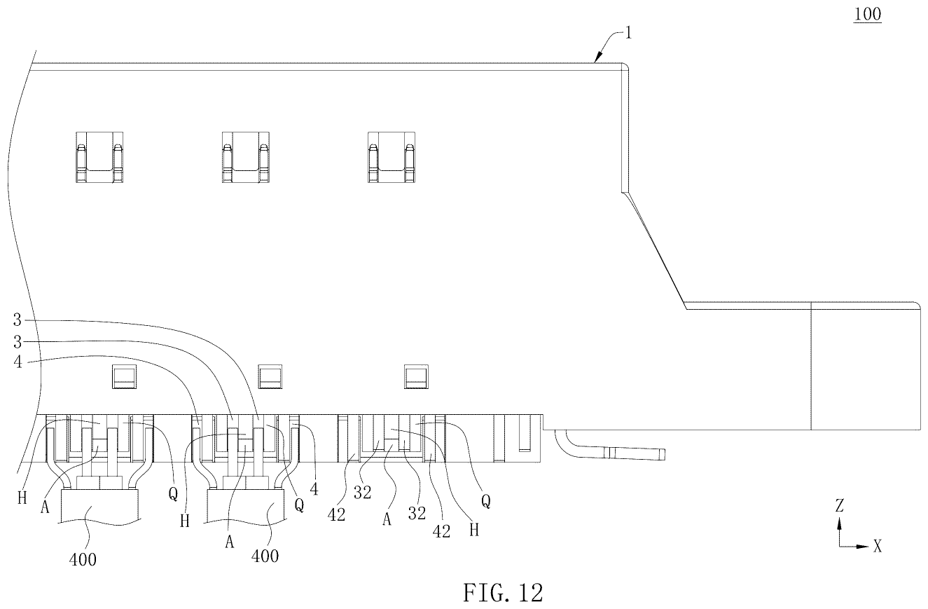

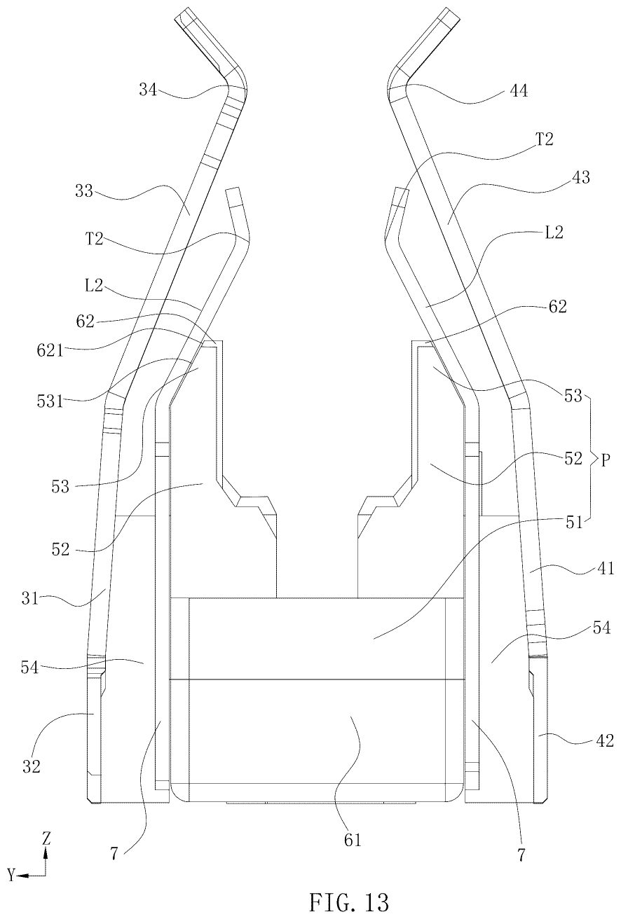

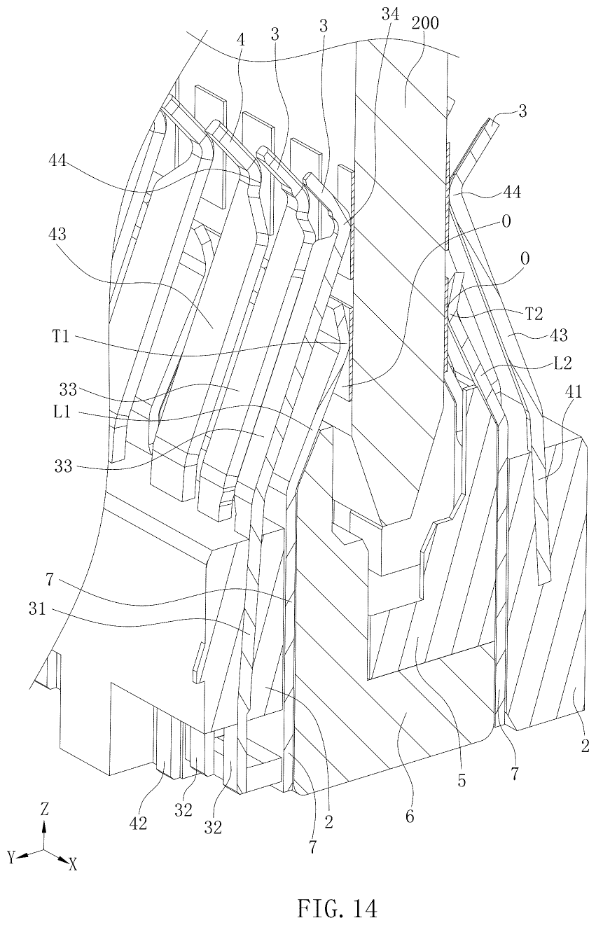

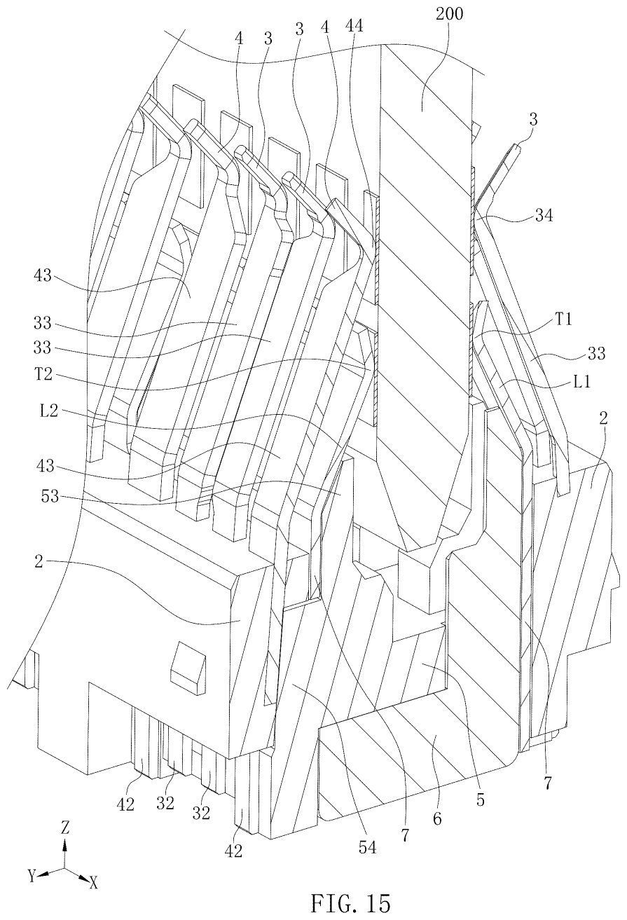

Referring to FIG. 2, FIG. 3, FIG. 5 and FIG. 9, each signal terminal 3 includes a signal tail portion 32, a signal retaining portion 31, a signal elastic portion 33 and a signal contact portion 34. The signal tail portion 32 extends out of the shell 1 from the lower surface of the shell 1 and is soldered to a circuit board 300 (and in other embodiments, the signal tail portion 32 may be connected to a cable). A surface of the circuit board 300 is provided with a signal soldering plate 302, and the signal tail portion 32 is soldered to the signal soldering plate 302 (that is, the soldering method is SMT). In other embodiments, it is possible that the circuit board 300 is provided with a hole matched with the signal tail portion 32, and the signal tail portion 32 is inserted into the hole (that is, the soldering method is DIP). The signal tail portion 32 includes a signal soldering portion 321 soldered to the surface of the circuit board 300 and a signal bending portion 322 connected to the signal soldering portion 321 and the signal retaining portion 31. Each plastic block 2 and the signal retaining portion 31 are insert-molded, and the signal retaining portion 31 is formed by extending upward from the signal bending portion 322. The insertion direction of the mating component 200 is perpendicular to the circuit board 300. In other embodiments, the signal retaining portion 31 may be formed by firstly extending upward and then bending and extending along the front-rear direction, and the insertion direction of the mating component 200 is not perpendicular to the circuit board 300. The signal elastic portion 33 is formed by extending obliquely upward from the signal retaining portion 31, and the signal clastic portion 33 extends upward to form a signal contact portion 34 protruding into the insertion slot 11. When the mating component 200 is inserted into the insertion slot 11, the signal contact portion 34 is in contact with the mating component 200, and the signal elastic portion 33 may swing.

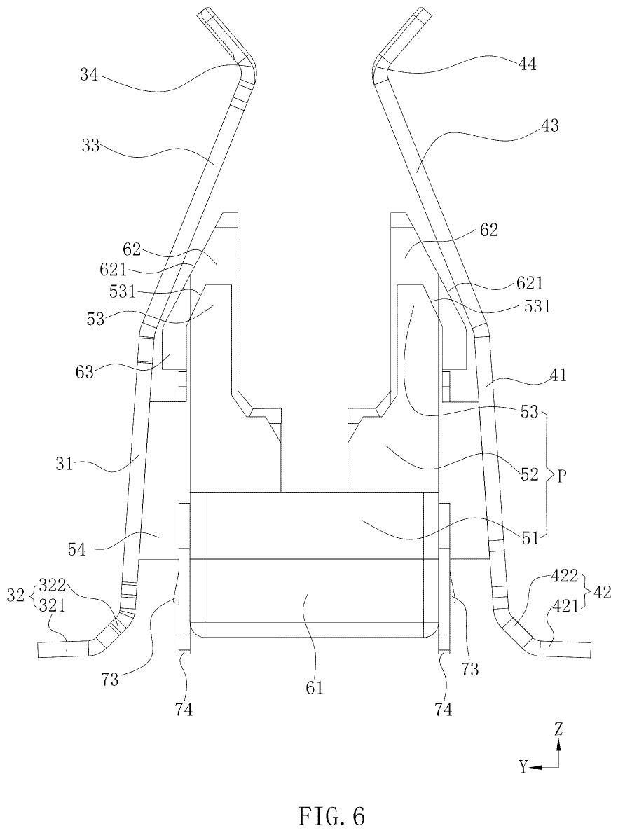

Referring to FIG. 3, FIG. 5 and FIG. 6, in the front-rear direction, the signal clastic portion 33 is located closer to the insertion slot 11 relative to the signal tail portion 32. The signal retaining portion 31 is entirely in a flat plate shape and extends obliquely toward the insertion slot 11 upward from bottom thereof, thereby connecting the signal clastic portion 33 and the signal tail portion 32. The signal retaining portion 31 does not have a bending portion, and a length of the signal retaining portion 31 is the shortest length, such that the signal transmission path is also the shortest path, thus enhancing the signal transmission characteristics of each signal terminal 3.

Referring to FIG. 2, FIG. 3, FIG. 5 and FIG. 9, each ground terminal 4 includes a grounding tail portion 42, a grounding retaining portion 41, a grounding clastic portion 43 and a grounding contact portion 44. The grounding tail portion 42 extends out of the shell 1 from the lower surface of the shell 1 and is soldered to the circuit board 300 (and in other embodiments, the grounding tail portion 42 may be connected to a cable). The surface of the circuit board 300 is provided with a grounding soldering plate 303, and the grounding tail portion 42 is soldered to the grounding soldering plate 303 (that is, the soldering method is SMT). In other embodiments, it is possible that the circuit board 300 is provided with a hole matched with the grounding tail portion 42, and the grounding tail portion 42 is inserted into the hole (that is, the soldering method is DIP). The grounding tail portion 42 includes a grounding soldering portion 421 soldered to the surface of the circuit board 300 and a grounding bending portion 422 connected to the grounding soldering portion 421 and the grounding retaining portion 41. The grounding retaining portion 41 and a corresponding plastic block 2 are insert-molded, and the grounding retaining portion 41 is formed by extending upward from the grounding bending portion 422. The insertion direction of the mating component 200 is perpendicular to the circuit board 300. In other embodiments, the grounding retaining portion 41 may be formed by firstly extending upward and then bending and extending along the front-rear direction, and the insertion direction of the mating component 200 is not perpendicular to the circuit board 300. The grounding retaining portion 41 includes a narrow portion 412 and a wide portion 411 located above the narrow portion 412, and in the left-right direction, a dimension of the narrow portion 412 is less than a dimension of the wide portion 411. The grounding elastic portion 43 is formed by extending obliquely upward from the grounding retaining portion 41, and the grounding elastic portion 43 extends upward to form a grounding contact portion 44 protruding into the insertion slot 11. When the mating component 200 is inserted into the insertion slot 11, the grounding contact portion 44 is in contact with the mating component 200, and the grounding clastic portion 43 may swing.

Referring to FIG. 3, FIG. 5 and FIG. 6, in the front-rear direction, the grounding elastic portion 43 is located closer to the insertion slot 11 relative to the grounding tail portion 42. The grounding retaining portion 41 is entirely in a flat plate shape and extends obliquely toward the insertion slot 11 upward from bottom thereof, thereby connecting the grounding elastic portion 43 and the grounding tail portion 42. The grounding retaining portion 41 does not have a bending portion. Viewing along the left-right direction, shapes of the grounding retaining portion 41 and the signal retaining portion 31 are matched, and a length of the grounding retaining portion 41 is the shortest length, such that the grounding return path is also the shortest.

Referring to FIG. 2, FIG. 3, FIG. 5 and FIG. 9, the signal terminals 3 and the ground terminals 4 are arranged along the left-right direction to form two terminal rows R. The two terminal rows R are provided at two sides of the insertion slot 11 along the front-rear direction, and each terminal row R is insert-molded with a corresponding plastic block 2. In each terminal row R, the two adjacent signal terminals 3 form a differential terminal pair S, and each of a left side and a right side of the differential terminal pair S is provided with an adjacent ground terminal 4. The differential terminal pair S and the two adjacent ground terminals 4 at the left side and the right side of the differential terminal pair S form a terminal group r. The electrical connector 100 further includes a plurality of power terminals (not numbered) used to transmit power, which are provided at a side of each plastic block 2 in the left-right direction and accommodated in the shell 1.

Referring to FIG. 9, in each differential terminal pair S, an interval C1 between the two signal contact portions 34 is greater than an interval C2 between the two signal clastic portions 33, the interval C1 between the two signal contact portions 34 is greater than an interval C3 between the two signal tail portions 32, a distance D1 between the two signal contact portions 34 is greater than a distance D2 between the two signal elastic portions 33, and the distance D1 between the two signal contact portions 34 is greater than a distance D3 between the two signal tail portions 32.

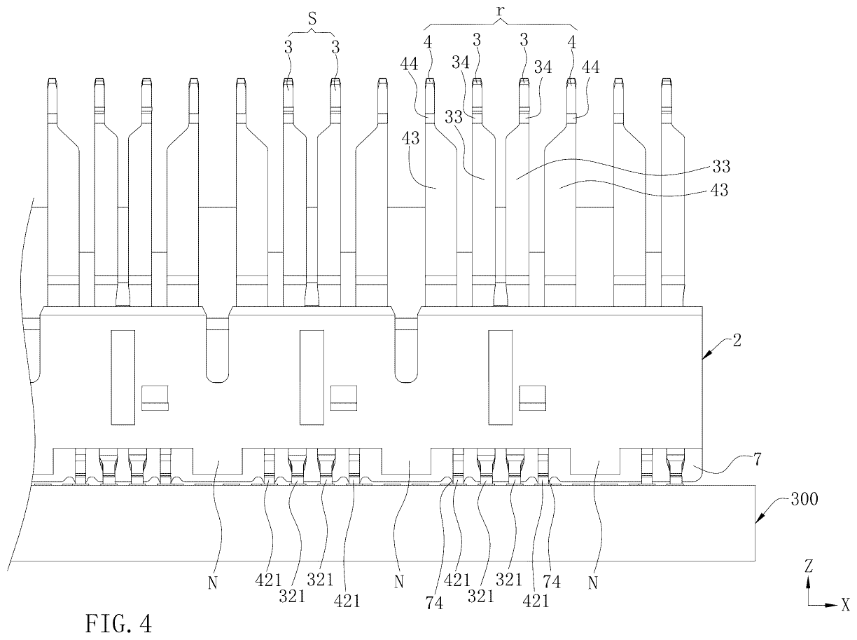

Referring to FIG. 2, FIG. 4, FIG. 5 and FIG. 9, in each terminal group r, an interval C4 between the two grounding tail portions 42 is less than an interval C5 between the two grounding retaining portions 41, and a distance D4 between the two grounding tail portions 42 is less than a distance D5 between the two grounding retaining portions 41. For the two ground terminals 4 provided to be adjacent to each other between two adjacent terminal groups r, a distance D6 between the two grounding tail portions 42 is greater than a distance D7 between two grounding retaining portions 41, and a corresponding spacer block N protrudes downward to be between the grounding bending portions 422 of the adjacent grounding tail portions 42 of the adjacent terminal groups r.

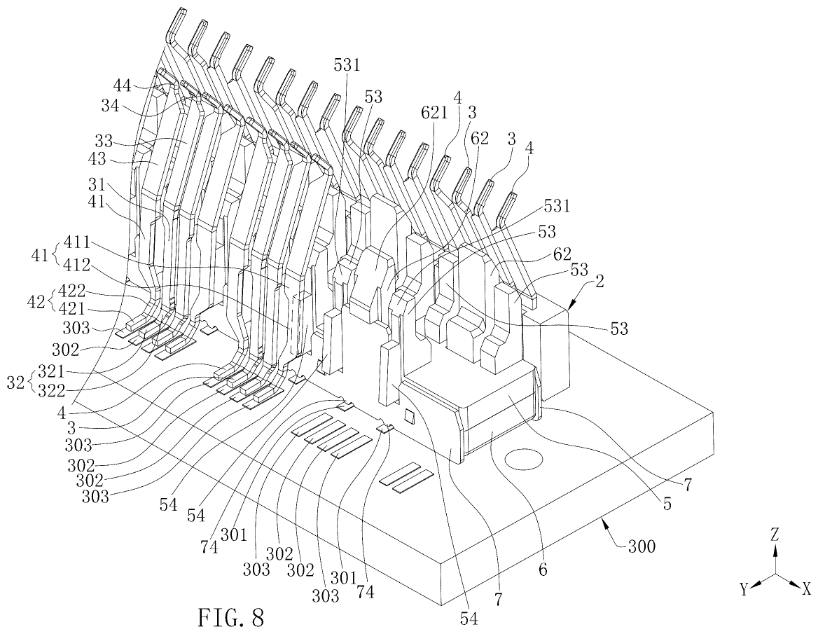

Referring to FIG. 4, FIG. 5, FIG. 8 and FIG. 9, in each terminal group r, a distance between the wide portion 411 and the differential terminal pair S is less than a distance between the narrow portion 412 and the differential terminal pair S, such that the narrow portion 412 is located away from the differential terminal pair S relative to the wide portion 411.

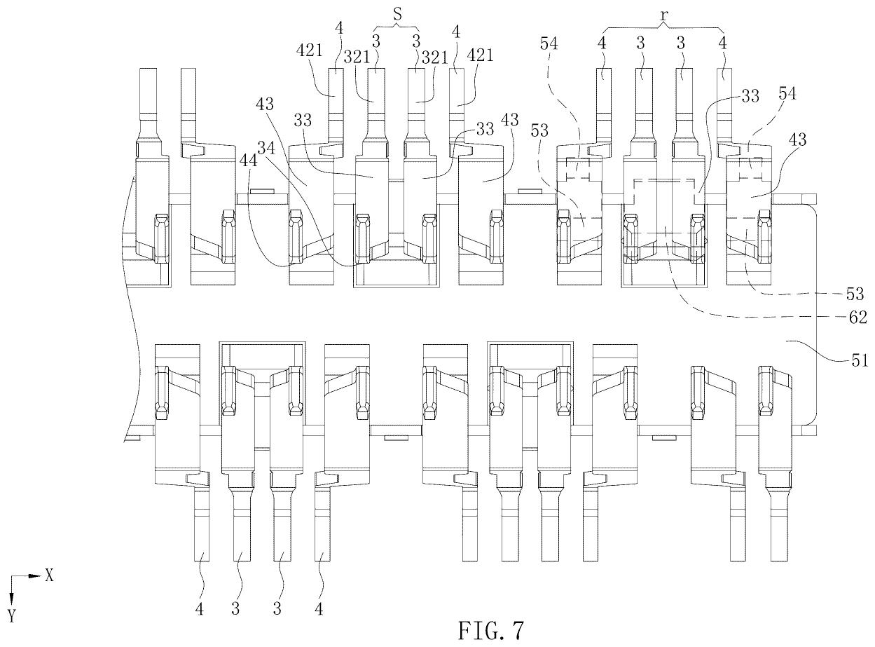

Referring to FIG. 3, FIG. 6, FIG. 7 and FIG. 8, the lossy member 5 is formed by a conductive plastic. In other embodiments, the lossy member 5 may be formed by a wave absorbing material, etc. The lossy member 5 is fixed between the two terminal rows R. The lossy member 5 includes a main body P and a plurality of protruding portions 54 formed by protruding toward the grounding retaining portions 41 from the main body P along the front-rear direction. The protruding portions 54 and the grounding retaining portions 41 one-to-one correspond to each other, and each protruding portion 54 is in direct contact with and electrically coupled to the corresponding narrow portion 412. In other embodiments, it is possible that each protruding portion 54 is not in direct contact with the corresponding narrow portion 412, and a small gap exists therebetween, thereby forming electrical coupling therebetween. The main body P includes a base 51, a plurality of protruding blocks 52 formed by extending upward from the base 51 and one-to-one corresponding to the ground terminals 4, and a plurality of extending portions 53 formed by extending upward from the protruding blocks 52. An upper end of each extending portion 53 passes upward beyond the bottom surface of the insertion slot 11 and one-to-one correspond to the grounding elastic portions 43, and the upper end of each extending portion 53 is lower than the grounding contact portions 44, thus preventing the grounding contact portions 44 and the mating component 200 to be in contact with the extending portions 53 after the mating component 200 is inserted. Viewing downward, each extending portion 53 overlaps with the corresponding grounding elastic portion 43. In the front-rear direction, the extending portions 53 are located between the grounding clastic portions 43 and the insertion slot 11, and each extending portion 53 does not protrude into the insertion slot 11 to be in contact with the mating component 200, thus preventing the extending portions 53 from affecting the mating component 200. A surface of each extending portion 53 facing toward the corresponding grounding elastic portion 43 is a first matching surface 531. The shape of the first matching surface 531 matches with the shape of the corresponding grounding elastic portion 43, and a distance between the first matching surface 531 and the corresponding grounding elastic portion 43 changes uniformly, such that the extending portion 53 may absorb the noise better, thus improving the high frequency characteristics of the electrical connector 100. The first matching surface 531 and the surface of the corresponding grounding clastic portion 43 are oblique straight surfaces. In other embodiments, the first matching surface 531 and the surface of the corresponding grounding clastic portion 43 may be other shapes such as curved surfaces, etc., as long as the shapes of the two match with each other.

Referring to FIG. 5 and FIG. 6, in the front-rear direction, a distance between each extending portion 53 and the corresponding grounding elastic portion 43 is greater than a distance between each protruding portion 54 and the corresponding grounding retaining portion 41. Each protruding portion 54 and the corresponding grounding retaining portion 41 are in contact to form the grounding circuit, and it is required to have a relatively large gap between each extending portion 53 and the corresponding grounding elastic portion 43 to reserve a moving space for the swinging of the grounding clastic portion 43. Thus, each extending portion 53 and the corresponding grounding clastic portion 43 are not electrically coupled, and each extending portion 53 has less amount of electrical charges passing therethrough without forming a grounding circuit. However, by providing each extending portion 53 to be close to the corresponding grounding elastic portion 43, the capacitive coupling at the grounding clastic portion 43 may be increased, and the noise between the signal terminals 3 may be absorbed, thus reducing the crosstalk.

Referring to FIG. 6 and FIG. 8, in the front-rear direction, a distance between the lossy member 5 and the wide portion 411 is greater than a distance between each protruding portion 54 and the corresponding narrow portion 412. That is, a distance between each protruding block 52 and the corresponding wide portion 411 is greater than the distance between each protruding portion 54 and the corresponding narrow portion 412. A gap exists between each protruding block 52 and the corresponding wide portion 411, and each protruding portion 54 is in contact with the corresponding narrow portion 412, such that electrical charges pass between the lossy member 5 and the ground terminals 4 to form grounding circuits. In addition, the narrow portion 412 is located away from the differential terminal pair S relative to the wide portion 411, such that a distance between each protruding portion 54 and the corresponding signal terminal 3 is increased, thus reducing the interference caused by the electrical charges of the protruding portion 54 to the corresponding signal terminal 3. A gap exists between each protruding block 52 and the corresponding wide portion 411, such that the wide portion 411 is not in contact with the protruding block 52, and the protruding block 52 corresponding to the wide portion 411 has less amount of electrical charges passing therethrough. The protruding block 52 is close to the wide portion 411, which may increase the capacitive coupling of the wide portion 411, absorb the noise between the signal terminals 3, and reduce the crosstalk. In addition, the gap between the wide portion 411 and the protruding block 52 may be reserved for the plastic block 2.

Referring to FIG. 2, FIG. 3, FIG. 5 and FIG. 7, the insulating plug member 6 is fixed between the two terminal rows R, and the lossy member 5 and the insulating plug member 6 are insert-molded. The insulating plug member 6 includes a body portion 61 and a plurality of protruding strips 62 formed by extending upward from the body portion 61 and one-to-one corresponding to the differential terminal pairs S. An upper end of each protruding strip 62 is higher than the bottom surface of the insertion slot 11 and is not higher than the corresponding signal contact portion 34, and a gap exists between each protruding strip 62 and the corresponding signal elastic portion 33. Viewing downward, each protruding strip 62 overlaps with the two signal elastic portions 33 of the corresponding differential terminal pair S, and in the front-rear direction, the protruding strips 62 are located between the signal elastic portions 33 and the insertion slot 11, thus increasing the capacitance near the signal elastic portion 33, thereby adjusting the impedance. In addition, a gap exists between each protruding strip 62 and the corresponding signal elastic portion 33, which may provide a moving space for the corresponding signal elastic portion 33 to swing. A surface of each protruding strip 62 facing toward the corresponding signal elastic portion 33 is a second matching surface 621. The shape of the second matching surface 621 matches with the shape of the corresponding signal elastic portion 33, and a distance between the second matching surface 621 and the corresponding signal elastic portion 33 changes uniformly, such that the impedance does not change significantly, and the impedance matches. The second matching surface 621 and the surface of the corresponding signal elastic portion 33 are oblique straight surfaces. In other embodiments, the second matching surface 621 and the surface of the corresponding signal elastic portion 33 may be other shapes such as curved surfaces, etc., as long as the shapes of the two match with each other.

Referring to FIG. 3 and FIG. 5, each protruding strip 62 corresponds to one of the guiding slots 21, and each protruding strip 62 has a clamping hook 63 matching with the corresponding plastic block 2. The insulating plug member 6 is mounted to be between the two terminal rows R upward from bottom thereof. The protruding strips 62 protrude upward out of the corresponding plastic block 2 along the guiding slots 21, and are stopped by and matched with the upper surface of the plastic block 2 by the hooks 63, thus fixing the insulating plug member 6 between the two terminal rows R.

Referring to FIG. 6 and FIG. 7, each protruding strip 62 corresponds to one of the differential terminal pairs S, and each extending portion 53 corresponds to one of the ground terminals 4. Thus, in the left-right direction, a dimension of each protruding strip 62 is greater than a dimension of each extending portion 53, and in the vertical direction, the upper ends of the extending portions 53 are located lower than the upper ends of the protruding strips 62. The dimension of each extending portion 53 in the left-right direction is less, and reducing the dimension of each extending portion 53 in the vertical direction may reduce the overall dimension of the protruding blocks 52 and the extending portions 53 in the vertical direction, thereby preventing the protruding blocks 52 and the extending portions 53 from breaking due to being excessively long. In addition, the lossy member 5, while absorbing the noise between the signal terminals 3, may also absorb the signal transmitted by each signal terminal 3 toward the receiving end. Thus, the insertion loss of the electrical connector 100 may increase, such that the SI of the electrical connector 100 is deteriorated. The protruding blocks 52 are not provided to be longer, such that the length of each extending portion 53 is not excessively long, and the portion of each extending portion 53 close to the corresponding signal terminal 3 is not too much, thereby reducing the portion of the signal transmitted by the corresponding signal terminal 3 toward the receiving end being absorbed by each extending portion 53, optimizing the insertion loss of the electrical connector 100, and enhancing the SI characteristics of the electrical connector 100.

Referring to FIG. 6 and FIG. 7, each extending portion 53 is close to the corresponding grounding elastic portion 43, thus reducing the crosstalk. However, the extending portion 53 may also absorb the signal transmitted by the corresponding signal terminal 3 toward a receiving end. In the front-rear direction, a distance between each protruding strip 62 and the corresponding signal elastic portion 33 is less than a distance between each extending portion 53 and the corresponding grounding elastic portion 43, thus increasing the distance between each extending portion 53 and the corresponding grounding elastic portion 43, and increasing the distance between each extending portion 53 and the corresponding signal terminal 3, thereby reducing the portion of the signal transmitted by the corresponding signal terminal 3 toward the receiving end being absorbed by each extending portion 53, and enhancing the SI characteristics of the electrical connector 100. Further, a portion of each protruding strip 62 close to the corresponding signal elastic portion 33 may form the clamping hook 63 matched with the plastic block 2.

Referring to FIG. 5, in the front-rear direction, the protruding blocks 52, the extending portions 53 and the protruding strips 62 are all provided at an outer side of the insertion slot 11 without extending to be within the insertion slot 11, and the distance between each protruding block 52 and the insertion slot 11 and a distance between each extending portion 53 and the insertion slot 11 are both greater than a distance between each protruding strip 62 and the insertion slot 11. In the manufacturing process, it is possible that the protruding blocks 52, the extending portions 53 and the protruding strips 62 may form protruding barbs extending toward the insertion slot 11. Thus, the protruding blocks 52 and the protruding strips 62 do not extend to the insertion slot 11, thus preventing the protruding barbs from interfering with the mating component 200. In addition, the lossy member 5 is conductive, and the lossy member 5 is provided to be further away from the insertion slot 11, thus preventing the protruding barbs from being in contact with and affecting the mating component 200.

Referring to FIG. 2, FIG. 3 and FIG. 8, each metal sheet 7 is assembled and fixed between a corresponding terminal row R and the lossy member 5, thereby isolating the signal terminals 3 and the lossy member 5. In other embodiments, each metal sheet 7 may be insert-molded with the lossy member 5, thereby being fixed between the corresponding terminal row R and the lossy member 5. Each metal sheet 7 includes a plurality of opening slots 71 one-to-one corresponding to the protruding portions 54 and a plurality of isolating portions 72 one-to-one corresponding to the differential terminal pairs S. The opening of each opening slot 71 is upward, and each protruding portion 54 passes through the corresponding opening slot 71 and is in contact with the corresponding narrow portion 412. Each isolating portion 72 is located between a corresponding one of the differential terminal pairs S and a corresponding one of the protruding strips 62.

Referring to FIG. 7 and FIG. 8, in the left-right direction, two protruding blocks 52 are provided between two adjacent protruding strips 62, and a dimension of each isolating portion 72 is greater than a dimension of each protruding strip 62. Viewing along the front-rear direction, each isolation portion 72 overlaps with a corresponding protruding strip 62 and the two protruding blocks 52 at the left side and the right side of each protruding strip 62, such that an area of the metal sheet 7 isolating the lossy member 5 and the signal terminals 3 becomes greater, and the isolating effect is better.

Referring to FIG. 8, in the vertical direction, each isolating portion 72 is lower than the clamping hook 63 but higher than the protruding portion 54. The clamping hook 63 may stop the isolating portion 72, thereby preventing the metal sheet 7 from moving upward. The isolating portion 72 is higher than the protruding portion 54, such that an area of the metal sheet 7 isolating the lossy member 5 and the signal terminals 3 becomes greater, and the isolating effect is better.

Referring to FIG. 3, FIG. 5 and FIG. 8, each metal sheet 7 has a plurality of fixing blocks 73 protruding toward the corresponding plastic block 2 and one-to-one corresponding to the fixing slots 22, and a distance D10 between each fixing slot 22 and the lower surface of the plastic block 2 is less than a distance D11 between each fixing slot 22 and the upper surface of the plastic block 2. The fixing slots 22 match with the fixing blocks 73 to fix the metal sheet 7 in the electrical connector 100, and the locations of the fixing slots 22 are provided below. In the process of mounting the metal sheet 7 to be between the corresponding plastic block 2 and the lossy member 5 upward from bottom thereof, after a large portion of the metal sheet 7 is mounted therein, the fixing blocks 73 start being in contact and interfering with the plastic block 2, such that the time of the fixing blocks 73 interfering with the plastic block 2 is shorter, and the metal sheet 7 is subjected to less force in the mounting process, thus preventing the metal sheet 7 from excessively scratching with the plastic block 2.

Referring to FIG. 3, FIG. 5 and FIG. 8, the fixing blocks 73 are located below the opening slots 71. In the mounting process of each metal sheet 7, the opening slots 71 match with the protruding portions 54 of the lossy member 5 to position the metal sheet 7 to its correct location, and then the metal sheet 7 is finally positioned and fixed to be between the corresponding plastic block 2 and the lossy member 5 by the matching of the fixing blocks 73 and the fixing slots 22.

Referring to FIG. 2, FIG. 3 and FIG. 8, each metal sheet 7 extends downward to form a plurality of soldering legs 74 to be soldered to the surface of the circuit board 300. The surface of the circuit board 300 is provided with a metal sheet soldering plate 301 to be soldered with the soldering legs 74 (that is, the soldering method is SMT). In other embodiments, it is possible that the circuit board 300 is provided with holes matched with the soldering legs 74, and the soldering legs 74 are inserted into the holes (that is, the soldering method is DIP). The soldering legs 74 are connected to a grounding layer (not shown) of the circuit board 300 by the metal sheet soldering plate 301, and the grounding tail portions 42 are also connected to the grounding layer of the circuit board 300 by the grounding soldering plate 303, thus optimizing the grounding paths of the ground terminals 4, such that the noise may be easily transmitted.

Referring to FIG. 4, FIG. 5 and FIG. 8, viewing along the front-rear direction, each soldering leg 74 and the corresponding grounding tail portion 42 are aligned in the front-rear direction. Compared to the case where each soldering leg 74 and the corresponding grounding tail portion 42 are provided to be staggered in the front-rear direction, when each soldering leg 74 and the corresponding grounding tail portion 42 are provided to align in the front-rear direction, a distance between each soldering leg 74 and the corresponding grounding tail portion 42 is shorter, thus optimizing the circuitry design of the grounding layer of the circuit board 300, such that the noise may flow back to the grounding layer rapidly.

Referring to FIG. 2 and FIG. 8, compared to the design in which the metal sheet soldering plate 301 and the grounding soldering plate 303 are integral, the metal sheet soldering plate 301 and the grounding soldering plate 303 are provided to be separated along the front-rear direction without being integral, such that in the process of soldering each soldering leg 74 and the corresponding grounding tail portion 42, the solder may be distributed more uniformly, without having most of the solder flowing toward one of the soldering leg 74 or the grounding tail portion 42.

FIG. 10 to FIG. 15 show an electrical connector 100 according to a second embodiment of the present invention, which is mainly different from the first embodiment in that:

Referring to FIG. 10, FIG. 11, FIG. 12 and FIG. 13, the shell 1 is not provided with the separation blocks M aligned with the spacer blocks N, and each plastic block 2 is not provided with the guiding slots 21 guiding the protruding strips 62 to protrude upward out of the plastic block 2. In the front-rear direction, the distance between each protruding strip 62 and the corresponding signal elastic portion 33 is greater than the distance between each extending portion 53 and the corresponding grounding elastic portion 43. Each protruding strip 62 is not provided with the clamping hook 63 matching with the upper surface of the corresponding plastic block 2. The signal tail portion 32 extends vertically along the vertical direction, and the signal tail portion 32 does not have the signal bending portion 322. The signal tail portion 32 is used to be connected to a cable. The grounding tail portion 42 extends along the vertical direction, and the grounding tail portion 42 does not have the grounding bending portion 422. The grounding tail portion 42 is used to be connected to a cable. The metal sheet 7 is not provided with the fixing blocks 73 matching with the corresponding plastic block 2, and the metal sheet 7 is not provided with the soldering legs 74 extending downward and soldered to the circuit board 300.

Referring to FIG. 11 and FIG. 12, each spacer block N protrudes downward to be between adjacent grounding tail portions 42 of adjacent terminal groups r. The lower surface of each plastic block 2 is further provided with a plurality of protrusions Q extending downward and located between two adjacent spacer blocks N in the left-right direction. Each protrusion Q has a supporting portion A. In the front-rear direction, the supporting portion A is located between the two signal tail portions 32 of the differential terminal pair S and the corresponding isolation portion 72. The supporting portion A is used to support the signal tail portions 32. Each protrusion Q is provided with a through hole H running along the front-rear direction. In the front-rear direction, projections of the two signal tail portions 32 of the differential terminal pair S are partially located in the through hole H. The through hole H reduces the material of each plastic block 2 near the signal tail portions 32, such that the capacitance near each signal tail portion 32 is reduced, thereby increasing the impedance near each signal tail portion 32, and adjusting the impedance such that the impedance matches.

Referring to FIG. 11 and FIG. 13, each protruding portion 54 of the lossy member 5 extends downward to pass beyond the main body P and extends toward a side where the corresponding grounding tail portion 42 is located in the left-right direction to be in contact with the corresponding grounding tail portion 42. In the front-rear direction, a dimension of each signal tail portion 32 is less than a dimension of each signal retaining portion 31, such that the inductance of each signal tail portion 32 is increased, thereby increasing the impedance of each signal tail portion 32, and adjusting the impedance such that the impedance matches. In the front-rear direction, a dimension of each grounding tail portion 42 is less than a dimension of each grounding retaining portion 41, such that the shape of each grounding tail portion 42 matches with the shape of each signal tail portion 32, allowing the ground terminals 4 and the signal terminal 3 to be formed altogether.

Referring to FIG. 11 and FIG. 13, the isolation portions 72 of the metal sheet 7 extend upward to form a plurality of signal extending portions L1 and a plurality of grounding extending portions L2. Each signal extending portion L1 is located between the two signal elastic portions 33 of a corresponding one of the differential terminal pairs S and a corresponding one of the protruding strips 62. An upper end of each of the signal extending portions L1 is higher than an upper end of each of the protruding strips 62 and lower than the signal contact portions 34. Each grounding extending portion L2 is located between a corresponding one of the grounding elastic portions 43 of the ground terminals 4 and a corresponding one of the extending portions 53. An upper end of each of the grounding extending portions L2 is higher than an upper end of each of the extending portions 53 and lower than the grounding contact portions 44. The opening of each opening slot 71 is downward, and the metal sheet 7 is mounted on the lossy member 5 downward from top thereof.

The signal extending portion L1 is provided with a signal mating portion T1, and the grounding extending portion L2 is provided with a grounding mating portion T2. The mating component 200 is provided with a metal sheet contact point O. After the mating component 200 is inserted into the insertion slot 11, the signal mating portion T1 and the grounding mating portion T2 are both in contact with the metal sheet contact point O.

Other structures are not reiterated.

In sum, the electrical connector 100 according to certain embodiments of the present invention has the following beneficial effects:
(1) The lossy member 5 and the ground terminals 4 of the electrical connector 100 are electrically coupled, thus forming the grounding circuit, optimizing the shielding effect, and reducing the crosstalk. However, the lossy member 5, due to its material characteristics, while absorbing the noise between the signal terminals 3, may also absorb the signal transmitted by each signal terminal 3 toward the receiving end. Thus, the insertion loss of the electrical connector 100 may increase, such that the SI of the electrical connector 100 is deteriorated. By adding the metal sheets 7 between the signal terminals 3 and the lossy member 5, the metal sheets 7 isolate the lossy member 5 and the signal terminals 3, such that the lossy member 5 does not absorb (or reducing the portion of) the signal transmitted by the signal terminals 3 toward the receiving end, thereby optimizing the insertion loss of the electrical connector 100, and enhancing the SI of the electrical connector 100.
(2) The signal elastic portion 33 and the grounding elastic portion 43 have large inductive coupling, thus resulting in larger crosstalk. An extending portion 53 extends from the base 51 of the lossy member 5. Viewing along the front-rear direction and viewing downward, each extending portion 53 overlaps with the corresponding grounding elastic portion 43, such that the extending portion 53 is close to the corresponding grounding elastic portion 43, thereby increasing the capacitive coupling of the grounding elastic portion 43. According to the formula

$$FEXT = \frac{{V}_{f}}{{V}_{a}} = \frac{Len}{RT} \times \frac{1}{2 v} \times ( \frac{{C}_{m L}}{{C}_{L}} - \frac{{L}_{m L}}{{L}_{L}} ) ,$$

the value of the FEXT is related to a difference value of the capacitive coupling and the inductive coupling, and increasing the capacitive coupling is practically providing more capacitive coupling to cancel the inductive coupling, thereby reducing the value of

$$( \frac{{C}_{m L}}{{C}_{L}} - \frac{{L}_{m L}}{{L}_{L}} ) ,$$

optimizing the FEXT and enhancing the high frequency characteristics. In addition, the lossy member 5 may absorb the noise between the signal terminals 3, and the extending portions 53 allow the lossy member 5 to have an increased area corresponding to the ground terminals 4, thus achieving a better effect of absorbing the noise between the signal terminals 3, such that the high frequency characteristics of the electrical connector 100 may be further improved.
(3) In each differential terminal pair S, the interval between the two signal contact portions 34 is greater than the interval between the two signal elastic portions 33, the interval between the two signal contact portions 34 is greater than the interval between the two signal tail portions 32, the distance between the two signal contact portions 34 is greater than the distance between the two signal elastic portions 33, and the distance between the two signal contact portions 34 is greater than the distance between the two signal tail portions 32, such that the distance between the two signal terminals 3 in the differential terminal pair S is reduced to form tight coupling, and the distance between two adjacent differential terminal pairs S is increased, thereby reducing the crosstalk.
(4) In each terminal group r, an interval C4 between the two grounding tail portions 42 is less than an interval C5 between the two grounding retaining portions 41, and a distance D4 between the two grounding tail portions 42 is less than a distance D5 between the two grounding retaining portions 41. Each grounding tail portion 42 extends toward the differential terminal pair S, thus reducing the crosstalk of the differential terminal pair S.
(5) For the two ground terminals 4 provided to be adjacent to each other between two adjacent terminal groups r, a distance D6 between the two grounding tail portions 42 is greater than a distance D7 between two grounding retaining portions 41, and a corresponding spacer block N is located between the adjacent grounding tail portions 42 of the adjacent terminal groups r, thus separating the adjacent differential terminal pairs S, and further reducing the crosstalk between the adjacent differential terminal pairs S.
(6) The isolation portions 72 of the metal sheet 7 extend upward to form a plurality of signal extending portions L1 and a plurality of grounding extending portions L2. Each signal extending portion L1 is located between the two signal elastic portions 33 of a corresponding one of the differential terminal pairs S and a corresponding one of the protruding strips 62. An upper end of each of the signal extending portions L1 is higher than an upper end of each of the protruding strips 62 and lower than the signal contact portions 34. Each grounding extending portion L2 is located between a corresponding one of the grounding elastic portions 43 of the ground terminals 4 and a corresponding one of the extending portions 53. An upper end of each of the grounding extending portions L2 is higher than an upper end of each of the extending portions 53 and lower than the grounding contact portions 44. The area of the metal sheet 7 isolating the lossy member 5 and the signal terminals 3 is larger, and the isolating effect is better.
(7) The signal extending portion L1 is provided with a signal mating portion T1, and the grounding extending portion L2 is provided with a grounding mating portion T2. The mating component 200 is provided with a metal sheet contact point O. After the mating component 200 is inserted into the insertion slot 11, the signal mating portion T1 and the grounding mating portion T2 are both in contact with the metal sheet contact point O, such that the signal mating portion T1 and the grounding mating portion T2 are in contact with a grounding layer (not shown) of the mating component 200, optimizing the grounding circuit of the metal sheet 7, such that the noise may be transmitted out more rapidly and more easily.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, comprising:
a shell, comprising an insertion slot to be inserted by a mating component;
two terminal rows accommodated in the shell, wherein the two terminal rows are respectively provided at two sides of the insertion slot along a front-rear direction, each of the terminal rows comprises a plurality of signal terminals and a plurality of ground terminals arranged in a left-right direction, each of the signal terminals comprises a signal contact portion inserted into the insertion slot and a signal elastic portion extending downward from the signal contact portion;
a lossy member, provided between the two terminal rows, wherein the lossy member comprises a main body and at least one protruding portion protruding toward a corresponding one of the ground terminals from the main body;
an insulating plug member, provided between the two terminal rows, wherein the insulating plug member comprises a body portion and a plurality of protruding strips formed by extending upward from the body portion; and
at least one metal sheet, provided between the main body and a corresponding one of the terminal rows, wherein the metal sheet comprises a plurality of opening slots and a plurality of isolating portions, the protruding portion passes through a corresponding one of the opening slots to be electrically coupled to the corresponding one of the ground terminals, and the isolating portions are located between the signal terminals and the insulating plug member.

2. The electrical connector according to claim 1, wherein a lower end of the metal sheet is provided with a plurality of soldering legs, the soldering legs are soldered to a surface of a circuit board, the ground terminals and the soldering legs are connected to a grounding layer of the circuit board, and viewing along the front-rear direction, the soldering legs and the ground terminals are aligned in the front-rear direction.

3. The electrical connector according to claim 1, wherein the insulating plug member and the lossy member are insert-molded, the main body comprises a base provided above the body portion and a plurality of protruding blocks formed by extending upward from the base, in the left-right direction, at least one of the protruding blocks is provided between two adjacent ones of the protruding strips, and viewing along the front-rear direction, each of the isolating portions overlaps with each of the protruding strips, and each of the isolating portions overlaps with two of the protruding blocks at a left side and a right side of each of the protruding strips.

4. The electrical connector according to claim 1, wherein in a vertical direction, an upper end of each of the isolation portions is located higher than an upper end of the protruding portion.

5. The electrical connector according to claim 1, further comprising two plastic blocks, wherein each of the plastic blocks is insert-molded with a corresponding one of the terminal rows, each of the protruding strips has a clamping hook, the clamping hook matches with an upper surface of a corresponding one of the plastic blocks to fix the insulating plug member to the plastic blocks, and the isolation portions are located below the clamping hooks of the protruding strips.

6. The electrical connector according to claim 1, further comprising two plastic blocks, wherein each of the plastic blocks is insert-molded with a corresponding one of the terminal rows, the metal sheet is provided with a plurality of fixing blocks formed by protruding toward a corresponding one of the plastic blocks along the front-rear direction relative to the isolation portions, each of the plastic blocks is provided with a plurality of fixing slots matching with the fixing blocks, and in a vertical direction, a distance between each of the fixing slots and a lower surface of each of the plastic blocks is less than a distance between each of the fixing slots and an upper surface of each of the plastic blocks.

7. The electrical connector according to claim 1, wherein the metal sheet is provided with a plurality of fixing blocks formed by protruding along the front-rear direction relative to the isolation portions, and in a vertical direction, the fixing blocks are lower than the opening slots.

8. The electrical connector according to claim 1, wherein each of the signal terminals further comprises a signal tail portion protruding out of the shell from a lower surface of the shell and a signal retaining portion extending upward from the signal tail portion and connected to the signal elastic portion, the signal elastic portion is located closer to the insertion slot than the signal tail portion, and the signal retaining portion is in a flat plate shape and extends obliquely toward the insertion slot upward from bottom thereof.

9. The electrical connector according to claim 1, wherein each of the ground terminals comprises a grounding tail portion protruding out of the shell from a lower surface of the shell, a grounding retaining portion formed by extending obliquely upward from the grounding tail portion and a grounding elastic portion formed by extending from the grounding retaining portion, the main body comprises a base provided above the body portion and a plurality of protruding blocks formed by extending upward from the base, each of the protruding blocks extends upward to form an extending portion, viewing downward, each of the extending portions overlaps with each of the grounding elastic portions of the ground terminals, in the front-rear direction, each of the extending portions is located between each of the grounding elastic portions of the ground terminals and the insertion slot, a surface of each of the extending portions facing the grounding elastic portion is a first matching surface, and a shape of the first matching surface matches with a shape of the grounding elastic portion.

10. The electrical connector according to claim 9, wherein viewing downward, each of the protruding strips overlaps with at least one of the signal elastic portions of the signal terminals, in the front-rear direction, each of the protruding strips are located between at least one of the signal elastic portions of the signal terminals and the insertion slot, a surface of each of the protruding strips facing the signal elastic portion is a second matching surface, and a shape of the second matching surface matches with a shape of the signal elastic portion.

11. The electrical connector according to claim 1, further comprising two plastic blocks, wherein each of the plastic blocks is insert-molded with a corresponding one of the terminal rows, each of the ground terminals comprises a grounding tail portion protruding out of the shell from a lower surface of the shell, the grounding tail portion comprises a grounding soldering portion soldered to a circuit board and a grounding bending portion connected to the grounding soldering portion and the grounding retaining portion, two adjacent ones of the signal terminals form a differential terminal pair, each of a left side and a right side of the differential terminal pair is provided with an adjacent one of the ground terminals, the differential terminal pair and the two adjacent ones of the ground terminals at the left side and the right side of the differential terminal pair form a terminal group, in the terminal group, an interval between the two grounding tail portions of the two adjacent ones of the ground terminals is less than an interval between the two grounding retaining portions of the two adjacent ones of the ground terminals, and each of the plastic blocks is provided with a plurality of spacer blocks extending downward and protruding to be between the grounding bending portions of two adjacent ones of the grounding tail portions of the ground terminals.

12. The electrical connector according to claim 11, wherein the shell is provided with a plurality of separation blocks extending downward, and the separation blocks and the spacer blocks are aligned in the front-rear direction.

13. The electrical connector according to claim 1, wherein two adjacent ones of the signal terminals form a differential terminal pair, each of a left side and a right side of the differential terminal pair is provided with an adjacent one of the ground terminals, each of the grounding terminals comprises a narrow portion electrically coupled to the protruding portion and a wide portion located above the narrow portion, in the left-right direction, a dimension of the narrow portion is less than a dimension of the wide portion, and a distance between the wide portion and the differential terminal pair adjacent thereto is less than a distance between the narrow portion and the differential terminal pair adjacent thereto, and in the front-rear direction, a distance between the lossy member and the wide portion is greater than a distance between the protruding portion and the narrow portion.

14. The electrical connector according to claim 1, wherein viewing downward, each of the protruding strips overlaps with at least one of the signal elastic portions of the signal terminals, in the front-rear direction, each of the protruding strips are located between at least one of the signal elastic portions of the signal terminals and the insertion slot, the isolation portions extend upward to form a plurality of signal extending portions, each of the signal extending portions is located between at least one corresponding one of the signal elastic portions of the signal terminals and a corresponding one of the protruding strips, and an upper end of each of the signal extending portions is higher than an upper end of each of the protruding strips and lower than the signal contact portions of the signal terminals.

15. The electrical connector according to claim 14, wherein each of the signal extending portions is provided with a signal mating portion, and the signal mating portion is in contact with the mating component.

16. The electrical connector according to claim 14, further comprising two plastic blocks, wherein each of the plastic blocks is insert-molded with a corresponding one of the terminal rows, a lower surface of each of the plastic blocks is provided with a plurality of protrusions extending downward, each of the signal terminals further comprises a signal tail portion protruding out of the shell from a lower surface of the shell, the signal tail portion is connected to a cable, two adjacent ones of the signal terminals form a differential terminal pair, each of the protrusions has a supporting portion, in the front-rear direction, the supporting portion is located between the two signal tail portions of the differential terminal pair and the corresponding ones of the isolation portions, each of the protrusions is provided with a through hole running along the front-rear direction, and in the front-rear direction, projections of the two signal tail portions of the differential terminal pair are partially located in the through hole.

17. The electrical connector according to claim 1, wherein each of the ground terminals comprises a grounding contact portion entering the insertion slot and a grounding elastic portion extending downward from the grounding contact portion, the isolation portions extend upward to form a plurality of grounding extending portions, each of the grounding extending portions is located between a corresponding one of the grounding elastic portions of the ground terminals and the main body, and the grounding extending portions are higher than the main body and lower than the grounding contact portion.

18. An electrical connector, comprising:
a shell, comprising an insertion slot to be inserted by a mating component;
two terminal rows accommodated in the shell, wherein the two terminal rows are respectively provided at two sides of the insertion slot along a front-rear direction, each of the terminal rows comprises a plurality of signal terminals and a plurality of ground terminals arranged in a left-right direction, each of the signal terminals comprises a signal contact portion inserted into the insertion slot and a signal elastic portion extending downward from the signal contact portion;
a lossy member, provided between the two terminal rows, wherein the lossy member comprises a main body and at least one protruding portion protruding toward a corresponding one of the ground terminals from the main body, and a lowest location of the lossy member is lower than a bottom surface of the insertion slot; and
at least one metal sheet, provided between the main body and a corresponding one of the terminal rows, wherein the metal sheet comprises a plurality of opening slots and a plurality of isolating portions, the protruding portion passes through a corresponding one of the opening slots to be electrically coupled to the corresponding one of the ground terminals, and the isolating portions shield the signal terminals along the front-rear direction.

19. The electrical connector according to claim 18, wherein a lower end of the metal sheet is provided with a plurality of soldering legs, the soldering legs are soldered to a surface of a circuit board, the ground terminals and the soldering legs are connected to a grounding layer of the circuit board, and viewing along the front-rear direction, the soldering legs and the ground terminals are aligned in the front-rear direction.

20. The electrical connector according to claim 18, further comprising an insulating plug member, provided between the two terminal rows, wherein the insulating plug member comprises a body portion and a plurality of protruding strips formed by extending upward from the body portion, viewing downward, each of the protruding strips overlaps with at least one of the signal elastic portions of the signal terminals, in the front-rear direction, the protruding strips are located between the signal elastic portions of the signal terminals and the insertion slot, the insulating plug member and the lossy member are insert-molded, the main body comprises a base provided above the body portion and a plurality of protruding blocks formed by extending upward from the base, in the left-right direction, at least one of the protruding blocks is provided between two adjacent ones of the protruding strips, and viewing along the front-rear direction, each of the isolating portions overlaps with each of the protruding strips, and each of the isolating portions overlaps with two of the protruding blocks at a left side and a right side of each of the protruding strips.
